(19) United States
(12) Patent Application Publication
(10) Pub. No.: US 2013/0138420 A1
(43) Pub. Date: May 30, 2013

(54) Managing Varying Instrumentation Volumes to Prevent Data Loss

(71) Applicant: Gary L. Swoboda, Sugarland, TX (US)

(72) Inventor: Gary L. Swoboda, Sugarland, TX (US)

(73) Assignee: TEXAS INSTRUMENTS INCORPORATED, Dallas, TX (US)

(21) Appl. No.: 12/974,650

(22) Filed: Dec. 21, 2010

Related U.S. Application Data
(60) Provisional application No. 61/289,501, filed on Dec. 23, 2009.

(51) Int. Cl. G06F 11/36

(52) U.S. Cl. CPC G06F 11/3652
USPC 703/28

(57) ABSTRACT

This invention is a method and apparatus for monitoring an electronic apparatus. Capture units capture data to be monitored. A first-in-first-out buffer corresponding to each capture unit buffers the captured data. The buffered data supplies a utilization unit. Captured data may be merged after or before buffering. This merged data may be further merged with other buffered data.

### CLAIM OF PRIORITY

This application claims priority under 35 U.S.C. 119(e)(1) to U.S. Provisional Application No. 61/289,501 filed Dec. 23, 2009.

### TECHNICAL FIELD OF THE INVENTION

The technical field of this invention is emulation and debug of electronic systems.

### BACKGROUND OF THE INVENTION

Advanced wafer lithography and surface-mount packaging technology are integrating increasingly complex functions at both the silicon and printed circuit board level of electronic design. Diminished physical access to circuits for test and emulation is an unfortunate consequence of denser designs and shrinking interconnect pitch. Designed-in testability is needed so the finished product is both controllable and observable during test and debug. Any manufacturing defect is preferably detectable during final test before a product is shipped. This basic necessity is difficult to achieve for complex designs without taking testability into account in the logic design phase so automatic test equipment can test the product.

In addition to testing for functionality and for manufacturing defects, application software development requires a similar level of simulation, observability and controllability in the system or sub-system design phase. The emulation phase of design should ensure that a system of one or more ICs (integrated circuits) functions correctly in the end equipment or application when linked with the system software. With the increasing use of ICs in the automotive industry, telecommunications, defense systems, and life support systems, thorough testing and extensive real-time debug becomes a critical need.

Functional testing, where the designer generates test vectors to ensure conformance to specification, still remains a widely used test methodology. For very large systems this method proves inadequate in providing a high level of detectable fault coverage. Automatically generated test patterns are desirable for full testability, and controllability and observability. These are key goals that span the full hierarchy of test from the system level to the transistor level. Another problem in large designs is the long time and substantial expense involved in design for test. It would be desirable to have testability circuitry, system and methods that are consistent with a concept of design-for-reusability. n this way, subsequent devices and systems can have a low marginal design cost for testability, simulation and emulation by reusing the testability, simulation and emulation circuitry, systems and methods that are implemented in an initial device. Without a proactive testability, simulation and emulation plan, a large amount of subsequent design time would be expended on test pattern creation and upgrading.

Even if a significant investment were made to design a module to be reusable and to fully create and grade its test patterns, subsequent use of a module may bury it in application specific logic. This would make its access difficult or impossible. Consequently, it is desirable to avoid this pitfall.

The advances of IC design are accompanied by decreased internal visibility and control, reduced fault coverage and reduced ability to toggle states, more test development and verification problems, increased complexity of design simulation and continually increasing cost of CAD (computer aided design) tools. In the board design the side effects include decreased register visibility and control, complicated debug and simulation in design verification, loss of conventional emulation due to loss of physical access by packaging many circuits in one package, increased routing complexity on the board, increased costs of design tools, mixed-mode packaging, and design for produceability. In application development, some side effects are decreased visibility of states, high speed emulation difficulties, scaled time simulation, increased debugging complexity, and increased costs of emulators. Production side effects involve decreased visibility and control, complications in test vectors and models, increased test complexity, mixed-mode packaging, continually increasing costs of automatic test equipment and tighter tolerances.

Emulation technology utilizing scan based emulation and multiprocessing debug was introduced more than 10 years ago. In 1988, the change from conventional in circuit emulation to scan based emulation was motivated by design cycle time pressures and newly available space for on-chip emulation. Design cycle time pressure was created by three factors. Higher integration levels, such as increased use of on-chip memory, demand more design time. Increasing clock rates mean that emulation support logic causes increased electrical intrusiveness. More sophisticated packaging causes emulator connectivity issues. Today these same factors, with new twists, are challenging the ability of a scan based emulator to deliver the system debug facilities needed by today's complex, higher clock rate, highly integrated designs. The resulting systems are smaller, faster, and cheaper. They have higher performance and footprints that are increasingly dense. Each of these positive system trends adversely affects the observation of system activity, the key enabler for rapid system development. The effect is called “vanishing visibility.”

FIG. 1 illustrates the trend in visibility and control over time and greater system integration in accordance with the prior art. Application developers prefer the optimum visibility level illustrated in FIG. 1. This optimum visibility level provides visibility and control of all relevant system activity. The steady progression of integration levels and increases in clock rates steadily decrease the actual visibility and control available over time. These forces create a visibility and control gap, the difference between the optimum visibility and control level and the actual level available. Over time, this gap will widen. Application development tool vendors are striving to minimize the gap growth rate. Development tools software and associated hardware components must do more with less resources and in different ways. Tackling this ease of use challenge is amplified by these forces.

With today's highly integrated System-On-a-Chip (SOC) technology, the visibility and control gap has widened dramatically over time. Traditional debug options such as logic analyzers and partitioned prototype systems are unable to keep pace with the integration levels and ever increasing clock rates of today's systems. As integration levels increase, system buses connecting numerous subsystem components move on chip, denying traditional logic analyzers access to these buses. With limited or no significant bus visibility, tools like logic analyzers cannot be used to view system activity or provide the trigger mechanisms needed to control the system under development. A loss of control accompanies this loss in visibility, as it is difficult to control things that are not accessible.

To combat this trend, system designers have worked to keep these buses exposed. Thus the system components were built in a way that enabled the construction of prototyping systems with exposed buses. This approach is also under siege from the ever-increasing march of system clock rates. As the central processing unit (CPU) clock rates increase, chip to chip interface speeds are not keeping pace. Developers find that a partitioned system's performance does not keep pace with its integrated counterpart, due to interface wait states added to compensate for lagging chip to chip communication rates. At some point, this performance degradation reaches intolerable levels and the partitioned prototype system is no longer a viable debug option. In the current era production devices must serve as the platform for application development.

Increasing CPU clock rates are also limiting availability of other simple visibility mechanisms. Since the CPU clock rates can exceed the maximum I/O state rates, visibility ports exporting information in native form can no longer keep up with the CPU. On-chip subsystems are also operated at clock rates that are slower than the CPU clock rate. This approach may be used to simplify system design and reduce power consumption. These developments mean simple visibility ports can no longer be counted on to deliver a clear view of CPU activity. As visibility and control diminish, the development tools used to develop the application become less productive. he tools also appear harder to use due to the increasing tool complexity required to maintain visibility and control. The visibility, control, and ease of use issues created by systems-on-a-chip tend to lengthen product development cycles.

Even as the integration trends present developers with a tough debug environment, they also present hope that new approaches to debug problems will emerge. The increased densities and clock rates that create development cycle time pressures also create opportunities to solve them. On-chip, debug facilities are more affordable than ever before. As high speed, high performance chips are increasingly dominated by very large memory structures, the system cost associated with the random logic accompanying the CPU and memory subsystems is dropping as a percentage of total system cost. The incremental cost of several thousand gates is at an all time low. Circuits of this size may in some cases be tucked into a corner of today's chip designs. The incremental cost per pin in today's high density packages has also dropped. This makes it easy to allocate more pins for debug. The combination of affordable gates and pins enables the deployment of new, on-chip emulation facilities needed to address the challenges created by systems-on-a-chip.

When production devices also serve as the application debug platform, they must provide sufficient debug capabilities to support time to market objectives. Since the debugging requirements vary with different applications, it is highly desirable to be able to adjust the on-chip debug facilities to balance time to market and cost needs. Since these on-chip capabilities affect the chip's recurring cost, the scalability of any solution is of primary importance. “Pay only for what you need” should be the guiding principle for on-chip tools deployment. In this new paradigm, the system architect may also specify the on-chip debug facilities along with the remainder of functionality, balancing chip cost constraints and the debug needs of the product development team.

FIG. 2 illustrates a prior art emulator system 100 including four emulator components. These four components are: a debugger application program 110; a host computer 120; an emulation controller 130; and on-chip debug facilities 140. FIG. 2 illustrates the connections of these components. Host computer 120 is connected to an emulation controller 130 external to host 120. Emulation controller 130 is also connected to target system 140. The user preferably controls the target application on target system 140 through debugger application program 110.

Host computer 120 is generally a personal computer. Host computer 120 provides access the debug capabilities through emulator controller 130. Debugger application program 110 presents the debug capabilities in a user-friendly form via host computer 120. The debug resources are allocated by debug application program 110 on an as needed basis, relieving the user of this burden. Source level debug utilizes the debug resources, hiding their complexity from the user. Debugger application program 110 together with the on-chip trace and triggering facilities provide a means to select, record, and display chip activity of interest. Trace displays are automatically correlated to the source code that generated the trace log. The emulator provides both the debug control and trace recording function.

The debug facilities are preferably programmed using standard emulator debug accesses through a JTAG or similar serial debug interface. Since pins are at a premium, the preferred embodiment of the invention provides for the sharing of the debug pin pool by trace, trigger, and other debug functions with a small increment in silicon cost. Fixed pin formats may also be supported. When the pin sharing option is deployed, the debug pin utilization is determined at the beginning of each debug session before target system 140 is directed to run the application program. This maximizes the trace export bandwidth. Trace bandwidth is maximized by allocating the maximum number of pins to trace.

The debug capability and building blocks within a system may vary. Debugger application program 100 therefore establishes the configuration at runtime. This approach requires the hardware blocks to meet a set of constraints dealing with configuration and register organization. Other components provide a hardware search capability designed to locate the blocks and other peripherals in the system memory map. Debugger application program 110 uses a search facility to locate the resources. The address where the modules are located and a type ID uniquely identifies each block found. Once the IDs are found, a design database may be used to ascertain the exact configuration and all system inputs and outputs.

Host computer 120 generally includes at least 64 Mbytes of memory and is capable of running Windows 95, SR-2, Windows NT, or later versions of Windows. Host computer 120 must support one of the communications interfaces required by the emulator. These may include: Ethernet 10T and 100T, TCP/IP protocol; Universal Serial Bus (USB); Firewire IEEE 1394; and parallel port such as SPP, EPP and ECP.

Host computer 120 plays a major role in determining the real-time data exchange bandwidth. First, the host to emulator communication plays a major role in defining the maximum sustained real-time data exchange bandwidth because emulator controller 130 must empty its receive real-time data exchange buffers as fast as they are filled. Secondly, host computer 120 originating or receiving the real-time data exchange data must have sufficient processing capacity or disc bandwidth to sustain the preparation and transmission or processing and storing of the received real-time data exchange data. A state of the art personal computer with a Firewire communication channel (IEEE 1394) is preferred to obtain the highest real-time data exchange bandwidth. This bandwidth can be as much as ten times greater performance than other communication options.

Emulation controller 130 provides a bridge between host computer 120 and target system 140. Emulation controller 130 handles all debug information passed between debugger application program 110 running on host computer 120 and a target application executing on target system 140. A presently preferred minimum emulator configuration supports all of the following capabilities: real-time emulation; real-time data exchange; trace; and advanced analysis.

Emulation controller 130 preferably accesses real-time emulation capabilities such as execution control, memory, and register access via a 3, 4, or 7 bit scan based interface. Real-time data exchange capabilities can be accessed by scan or by using three higher bandwidth real-time data exchange formats that use direct target to emulator connections other than scan. The input and output triggers allow other system components to signal the chip with debug events and vice-versa. Bit I/O allows the emulator to stimulate or monitor system inputs and outputs. Bit I/O can be used to support factory test and other low bandwidth, non-time-critical emulator/target operations. Extended operating modes are used to specify device test and emulation operating modes. Emulator controller 130 is partitioned into communication and emulation sections. The communication section supports host communication links while the emulation section interfaces to the target, managing target debug functions and the device debug port. Emulation controller 130 communicates with host computer 120 using one of industry standard communication links outlined earlier herein. The host to emulator connection is established with off the shelf cabling technology. Host to emulator separation is governed by the standards applied to the interface used.

Emulation controller 130 communicates with the target system 140 through a target cable or cables. Debug, trace, triggers, and real-time data exchange capabilities share the target cable, and in some cases, the same device pins. More than one target cable may be required when the target system 140 deploys a trace width that cannot be accommodated in a single cable. All trace, real-time data exchange, and debug communication occurs over this link. Emulator controller 130 preferably allows for a target to emulator separation of at least two feet. This emulation technology is capable of test clock rates up to 70 MHZ and trace clock rates from 200 to 300 MHZ, or higher. Even though the emulator design uses techniques that should relax target system 140 constraints, signaling between emulator controller 130 and target system 140 at these rates requires design diligence. This emulation technology may impose restrictions on the placement of chip debug pins, board layout, and requires precise pin timings. On-chip pin macros are provided to assist in meeting timing constraints.

The on-chip debug facilities offer the developer a rich set of development capability in a two tiered, scalable approach. The first tier delivers functionality utilizing the real-time emulation capability built into a CPU's mega-modules. This real-time emulation capability has fixed functionality and is permanently part of the CPU while the high performance real-time data exchange, advanced analysis, and trace functions are added outside of the core in most cases. The capabilities are individually selected for addition to a chip. The addition of emulation peripherals to the system design creates the second tier functionality. A cost-effective library of emulation peripherals contains the building blocks to create systems and permits the construction of advanced analysis, high performance real-time data exchange, and trace capabilities. In the preferred embodiment five standard debug configurations are offered, although custom configurations are also supported. The specific configurations are covered later herein.

Clock rates of cores generating program and data trace have increased. This generates higher trace information volumes. A sophisticated trace protocol must be used in most cases to describe the program activity. This protocol may generate large volumes of data over short periods. Current trace architectures merge this data with other sources such as other cores as it is generated, with this logic operating at a lower frequency than the cores. When instantaneous volumes occur, the system is incapable of handling this volume and data is lost.

### SUMMARY OF THE INVENTION

This invention is a method and apparatus for monitoring an electronic apparatus. Capture units capture data to be monitored. A first-in-first-out buffer corresponding to each capture unit buffers the captured data. The buffered data supplied a utilization unit. Captured data may be merged after or before buffering. This merged data may be further merged with other buffered data.

### BRIEF DESCRIPTION OF THE DRAWINGS

These and other aspects of this invention are illustrated in the drawings, in which:

FIG. 1 illustrates the visibility and control of typical integrated circuits as a function of time due to increasing system integration;

FIG. 2 illustrates a prior art emulation system to which this invention is applicable;

FIG. 3 illustrates in block diagram form a typical integrated circuit employing configurable emulation capability of the prior art;

FIG. 4 illustrates a first prior art emulation data gathering system;

FIG. 5 illustrates another prior art emulation data gathering system;

FIG. 6 illustrates a first embodiment of this invention;

FIG. 7 illustrates a second embodiment of this invention including merged data streams; and

FIG. 8 illustrates another embodiment of this invention including merged data streams.

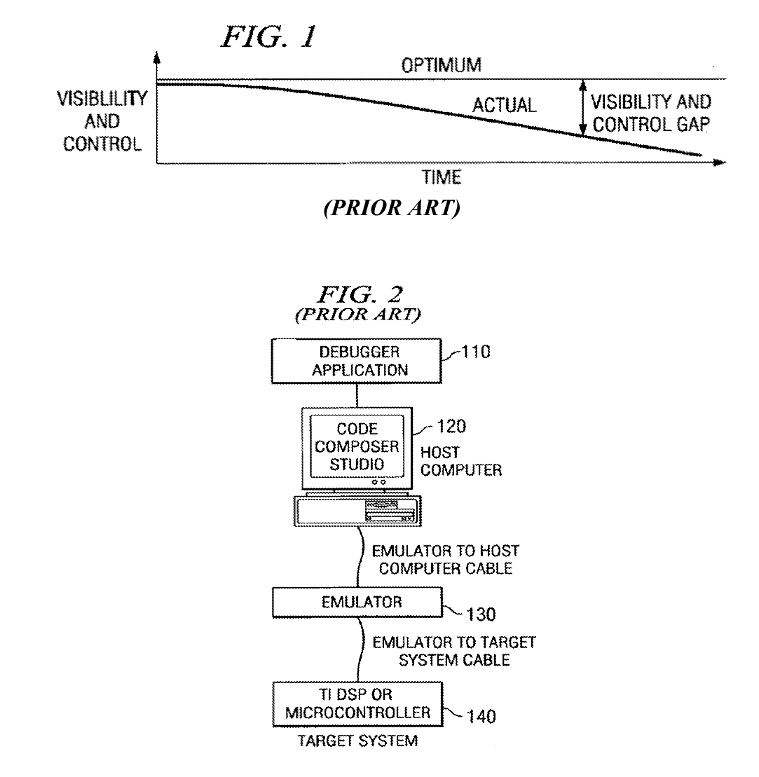

### DETAILED DESCRIPTION OF PREFERRED EMBODIMENTS

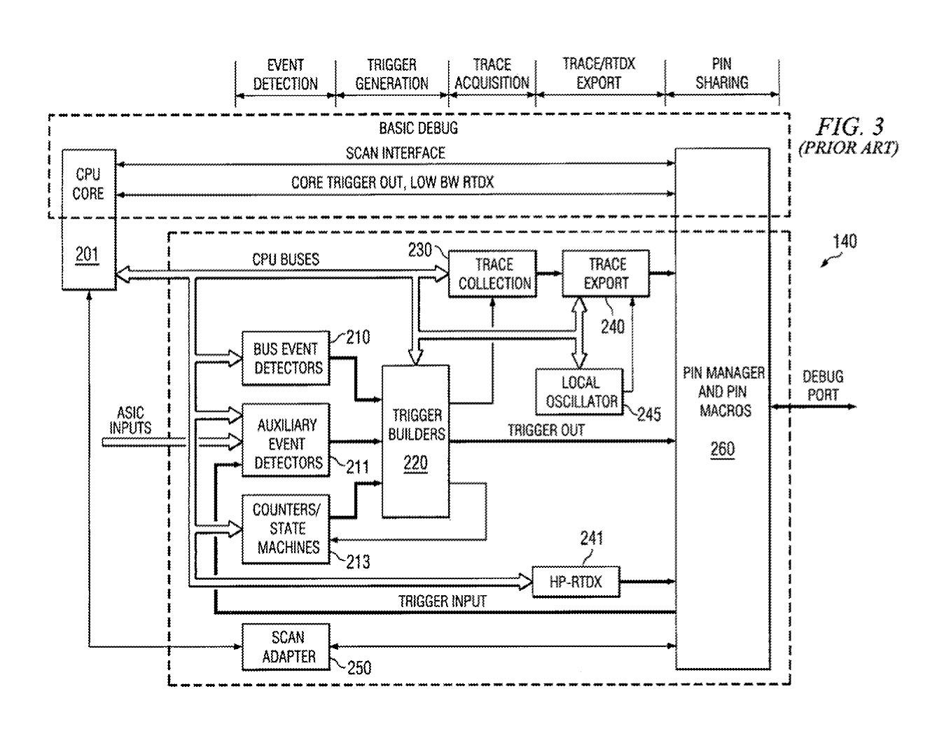

FIG. 3 illustrates an example of one on-chip debug architecture embodying target system 140. The architecture uses several module classes to create the debug function. One of these classes is event detectors including bus event detectors 210, auxiliary event detectors 211 and counters/state machines 213. A second class of modules is trigger generators including trigger builders 220. A third class of modules is data acquisition including trace collection 230 and formatting. A fourth class of modules is data export including trace export 240, and real-time data exchange export 241. Trace export 240 is controlled by clock signals from local oscillator 245. Local oscillator 245 will be described in detail below. A final class of modules is scan adaptor 250, which interfaces scan input/output to CPU core 201. Final data formatting and pin selection occurs in pin manager and pin micros 260.

The size of the debug function and its associated capabilities for any particular embodiment of a system-on-chip may be adjusted by either deleting complete functions or limiting the number of event detectors and trigger builders deployed. Additionally, the trace function can be incrementally increased from program counter trace only to program counter and data trace along with ASIC and CPU generated data. The real-time data exchange function may also be optionally deployed. The ability to customize on-chip tools changes the application development paradigm. Historically, all chip designs with a given CPU core were limited to a fixed set of debug capability. Now, an optimized debug capability is available for each chip design. This paradigm change gives system architects the tools needed to manage product development risk at an affordable cost. Note that the same CPU core may be used with differing peripherals with differing pin outs to embody differing system-on-chip products. These differing embodiments may require differing debug and emulation resources. The modularity of this invention permits each such embodiment to include only the necessary debug and emulation resources for the particular system-on-chip application.

The real-time emulation debug infrastructure component is used to tackle basic debug and instrumentation operations related to application development. It contains all execution control and register visibility capabilities and a minimal set of real-time data exchange and analysis such as breakpoint and watchpoint capabilities. These debug operations use on-chip hardware facilities to control the execution of the application and gain access to registers and memory. Some of the debug operations which may be supported by real-time emulation are: setting a software breakpoint and observing the machine state at that point; single step code advance to observe exact instruction by instruction decision making; detecting a spurious write to a known memory location; and viewing and changing memory and peripheral registers.

Real-time emulation facilities are incorporated into a CPU mega-module and are woven into the fabric of CPU core 201. his assures designs using CPU core 201 have sufficient debug facilities to support debugger application program 110 baseline debug, instrumentation, and data transfer capabilities. Each CPU core 201 incorporates a baseline set of emulation capabilities. These capabilities include but are not limited to: execution control such as run, single instruction step, halt and free run; displaying and modifying registers and memory; breakpoints including software and minimal hardware program breakpoints; and watchpoints including minimal hardware data breakpoints.

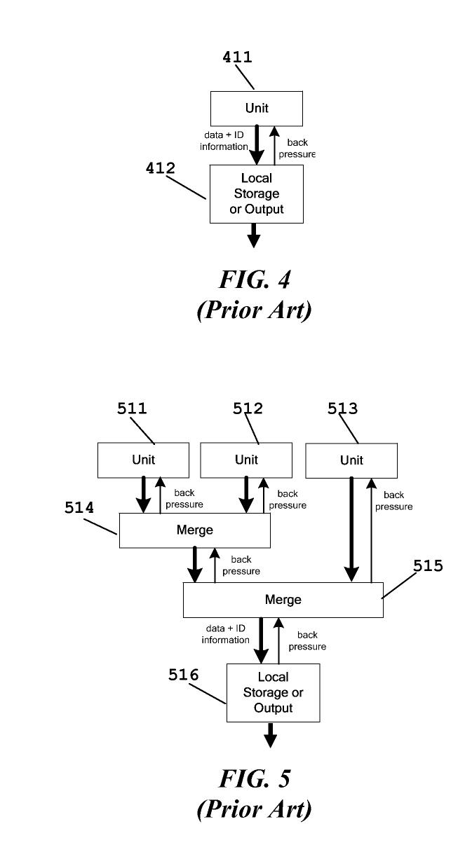

FIG. 4 illustrates an embodiment of the prior art. FIG. 4 illustrates a single unit 411 and a single local storage or output 412. Unit 411 supplies emulation or debug data captured from the monitored system as described above and identification (ID) information to local storage or output 412. Local storage or output 412 stores this data and ID information for further use. Local storage or output 412 supplies a back pressure signal to unit 411. Unit 411 is subject to the back pressure signal to control the rate of the data supplied. This is useful at times such as when a receiving external device is not ready for more data and local storage or output 412 has reached its storage capacity.

FIG. 5 illustrates an additional embodiment of the prior art. FIG. 5 illustrates a more complex system than shown in FIG. 4. FIG. 5 illustrates plural units 511, 512 and 513 which supply captured emulation or debug data. Units 511 and 512 supply captured data to first merge unit 514 which combines the two data streams. First merge unit 514 supplies a back pressure signal to each of units 511 and 512 as described above.

The merged data stream output of first merge unit 514 supplies second merge unit 515. First merge unit 514 is subject to a back pressure signal from second merge unit 515. Unit 513 supplies captured emulation and debug data directly to second merge unit 515. Unit 513 is subject to a back pressure signal from second merge unit 515. Second merge unit 515 merges the composite data stream from first merge unit 514 and the data stream from unit 513 into another merged data stream. Second merge unit 515 supplies this further merged data stream to local storage of output 516 and is subject to a back pressure signal from local storage or output 516.

Summarizing the current art, units present their instrumentation data along with source identification information to either a storage or output mechanism (FIG. 4) or to a more complicated merge system before presentation to a storage or output mechanism (FIG. 5). In each of these prior art techniques the instrumentation data generally includes source identification information. The local storage or output may apply back pressure to the source to control the rate of data supply. This data transfer is generally synchronous and sometimes crosses voltage domains.

The clock rate of monitored systems generating instrumentation data is generally higher that the clock rate used to transmit this data. Thus the source can generate more data than can be absorbed by the destination. When merging many sources as shown in FIG. 5 collisions of peak loads generated by multiple sources cannot be handled without losing data. Generally increasing the data transfer bus width does not solve this problem.

In a system where debug is desired, it is often desirable to collect information about system operation with hardware monitors of central processing units (CPUs), direct memory access units (DMAs) and other units. The information generated by these units may be merged into a single stream of instrumentation data. These units may occasionally generate enough information to saturate the stream of instrumentation data without regard to other units sharing the stream. It is also possible that units will simultaneously generate peak output loading. In the prior art data is lost unless units sufficiently buffer data near the source of their instrumentation data.

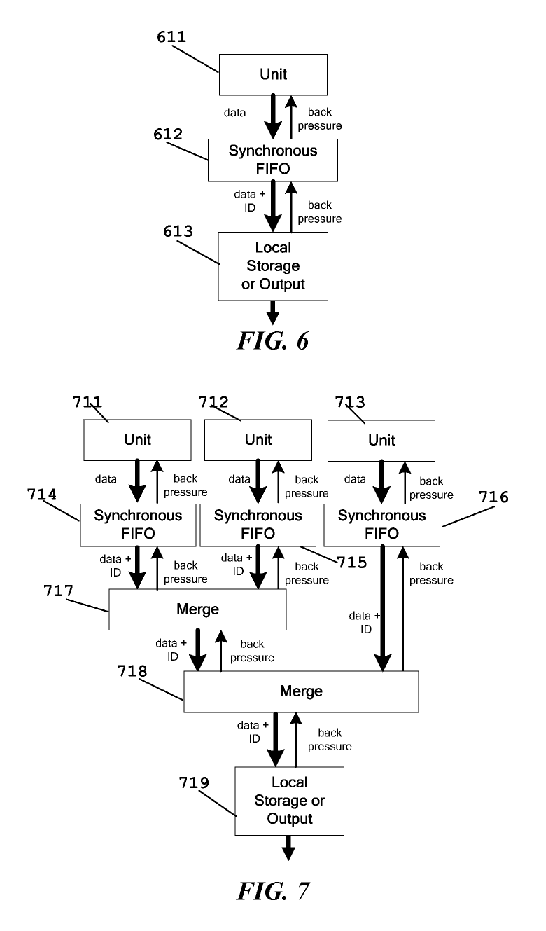

This invention is a solution to this problem. This invention buffers the data generated by sources capable of generating the aforementioned peak loads. FIG. 6 illustrates a single unit 611 and a single local storage or output 612. Unit 611 supplies emulation or debug data to synchronous first-in-first-out (FIFO) 612. FIFO 612 can supply a back pressure signal to unit 611. FIFO 612 is a simple synchronous FIFO that merely buffers the instrumentation data. FIFO 612 supplies data to local storage or output 612. Local storage or output 612 stores this data and ID information for further use. Local storage or output 612 supplies a back pressure signal to unit 611.

FIG. 7 illustrates an additional embodiment of this invention. FIG. 7 illustrates a more complex system than shown in FIG. 6. FIG. 7 illustrates plural units 711, 712 and 713 which supply captured emulation or debug data. Unit 711 supplies captured data to FIFO 714. FIFO 714 is similar to FIFO 612. Unit 711 is subject to a back pressure signal from FIFO 714. Unit 712 supplies captured data to FIFO 715. FIFO 716 is similar to FIFO 612. Unit 712 is subject to a back pressure signal from FIFO 715. FIFO 714 and FIFO 715 supply captured data to first merge unit 717 which combines the two data streams. First merge unit 717 supplies a back pressure signal to each of FIFOs 714 and 714. The merged data stream output of first merge unit 717 supplies second merge unit 718. First merge unit 717 is subject to a back pressure signal from second merge unit 718. Unit 713 supplies captured data to FIFO 716. FIFO 716 is similar to FIFO 612. Unit 713 is subject to a back pressure signal from FIFO 716. FIFO 716 supplies captured emulation and debug data to second merge unit 718. FIFO 716 is subject to a back pressure signal from second merge unit 718. Second merge unit 718 merges the composite data stream from first merge unit 717 and the data stream from FIFO 716 into another merged data stream. Second merge unit 718 supplies this further merged data stream to local storage of output 719 and is subject to a back pressure signal from local storage or output 719.

This invention handles the collision of peak loads placing a synchronous FIFO at the output of each unit 611, 711, 712 and 713. As shown in FIGS. 6 and 7 the corresponding ID is attached to the data at FIFO output before any merge process.

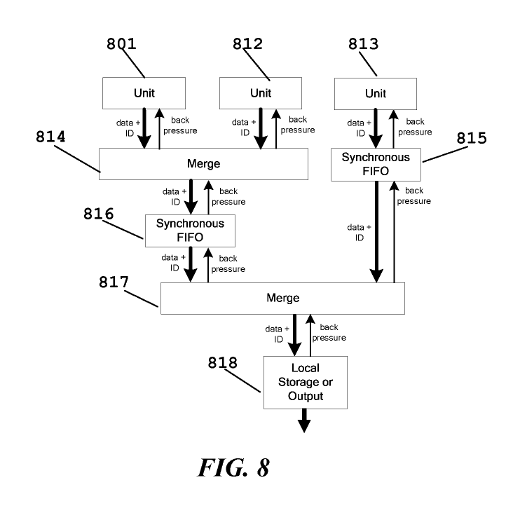

FIG. 8 illustrates an alternative to the system of FIG. 7. The merge process can create throughput bottlenecks. The system of FIG. 8 relieves these bottlenecks by placing a synchronous or asynchronous FIFO in the merge path. FIG. 8 illustrates plural units 811, 812 and 813 which supply captured emulation or debug data. Unit 811 supplies captured data to first merge unit 814. Unit 812 supplies captured data to first merge unit 814. First merge unit 814 which combines the two data streams. Note the data from units 811 and 812 each include a corresponding ID because otherwise the identity would be lost in first merge unit 804. The merged data stream output of first merge unit 814 supplies FIFO 816. First merge unit 814 is subject to a back pressure signal from FIFO 816. Unit 813 supplies captured data to FIFO 815. Unit 813 is subject to a back pressure signal from FIFO 815. FIFO 815 supplies captured emulation and debug data to second merge unit 817. Second merge unit 817 merges the composite data stream from first merge unit 816 and the data stream from FIFO 815 into another merged data stream. Second merge unit 817 supplies this further merged data stream to local storage of output 818 and is subject to a back pressure signal from local storage or output 818.

This invention employs FIFOs to level the load of the merged sources. If the average bandwidth supplied by all units is less than or equal to the bandwidth of the input to the local storage or output and the FIFOs are sufficient to absorb peak loads, then no instrumentation data is lost.

What is claimed is:

1. A monitoring subsystem in an electronic apparatus comprising:
at least one capture unit capturing data to be monitored having a output to supply said captured data;
a first-in-first-out buffer corresponding to each of said at least one capture unit having an input connected to said output of said corresponding capture unit and an output, said first-in-first-out buffer temporarily storing said captured data; and
a utilization unit having an input connected to said output of said first-in-first-out buffer.

2. The electronic apparatus of claim 1, wherein:
said at least one capture unit includes a first plurality of capture units; and
said electronic apparatus further includes a first merge unit having inputs connected to said output of said first-in-first-out buffers corresponding to said first plurality of capture units and an output of a merged data stream connected to said input of said utilization unit.

3. The electronic apparatus of claim 2, wherein:
said at least one capture unit further includes an additional capture unit; and
said electronic apparatus further includes a second merge unit having a first input connected to said output of said first merge unit, a second input connected to said first-in-first-out buffer corresponding to said additional unit and an output of a merged data stream connected to said input of said utilization unit.

4. The electronic apparatus of claim 1, wherein:
said at least one plurality of capture units includes a first plurality of capture units; and
said electronic apparatus further includes a first merge unit having inputs connected to said outputs of said first plurality of capture units and an output of a merged data stream connected to said input of a first-in-first-out buffer.

5. A method of monitoring an electronic apparatus comprising the steps of:
capturing data to be monitored;
buffering said captured data in a first-in-first-out buffer; and
utilizing said buffered data from an output of said first-in-first-out buffer.

6. The method of claim 5, further comprising the steps of:
merging buffered captured data from plural first-in-first-out buffers.

7. The method of claim 6, further comprising the step of:
merging said merged data with captured data from another first-in-first-out buffer.

8. The method of claim 5, further comprising the steps of:
merging said captured data; and
buffering said merged data in a first-in-first-out buffer.
